(19) United States
(12) Patent Application Publication
(10) Pub. No.: US 2004/0143458 A1
(43) Pub. Date: Jul. 22, 2004

(54) Method and system for integrated processing of automatically collected interaction data

(75) Inventors: Otto Pulkkinen, Helsinki (FI); Matti Hakkinen, Espoo (FI); Jukka-Pekka Sarkka, Espoo (FI)

Correspondence Address: BRUCE LONDA, NORRIS, MCLAUGHLIN & MARCUS, P.A., 220 EAST 42ND STREET, 30TH FLOOR, NEW YORK, NY, 10017, US

(73) Assignee: Instrumentarium Corporation, Helsinki (FI)

(21) Appl. No.: 10/691,787

(22) Filed: Oct. 23, 2003

Related U.S. Application Data
(60) Provisional application No. 60/423,001, filed on Nov. 4, 2002.

(51) Int. Cl. G06F 17/60

(52) U.S. Cl. 705/2; 705/7

(57) ABSTRACT

A mediator method and system provides an interface between automatic real time input interaction data collection systems and software applications independent of output data format requirements of the applications and the data formats of input interaction data streams generated at the respective collection systems. The collected input interaction data is arranged in a standardized format to provide for integrated processing and interaction events are identified based on the integrated processing. Interaction event data is provided in real time to the respective applications in accordance with their data format requirements.

### CROSS REFERENCE TO RELATED APPLICATION

This application claims the benefit of U.S. Provisional Application No. 60/423,001 filed Nov. 4, 2002, assigned to the assignee of this application and incorporated by reference herein.

### FIELD OF THE INVENTION

The present invention relates generally to method and system for monitoring interactions in a tracking environment, and more particularly, method and system for integrated processing of interaction data automatically collected in real time from a tracking environment and formatting interaction event data, which is generated by the integrated processing, for use in real time by an information management application.

### BACKGROUND OF THE INVENTION

Healthcare facilities are increasing their utilization of information technology (“IT”) to improve the quality of care, increase the productivity of caregivers and reduce medical errors. In many prior art IT systems, the supply of input data to, and the display of output data resulting from processing performed at, the IT system depend upon real time interaction between a human, for example, a nurse or physician caregiver, and a stationary data input and display device, such as a desktop computer including a keyboard and display. This dependence upon real time interaction has prevented exploitation of all of the possible benefits associated with using IT in connection with providing healthcare services. Although the proliferation of wireless and handheld personal computing devices among caregivers is expected to alleviate the problem that data must be entered and viewed at a fixed location, even less obtrusive ways of interacting with an IT system in real time still are needed.

Automatic identification and data capture (“AIDC”) systems automatically and non-disruptively collect data from a tracking environment which can be used to identify and locate people, goods and equipment within the environment. AIDC technologies include, for example, bar coding, radio frequency identification (“RFID”), real time location systems (“RTLS”), voice recognition, smart cards, biometric recognition, machine vision and other related technologies. See, for example, Smart Medicine—The Application of Auto-ID Technology To Healthcare” by the MIT Auto-ID Center, incorporated by reference herein, for a description of the different uses of AIDC technology in a healthcare setting.

The healthcare industry, and also other industries that rely upon information management to improve efficiencies and operations, have recognized that the automatic real time data collection provided by AIDC technologies improves the ease with which data can be collected and then displayed for viewing in real time. For example, healthcare facilities have begun to implement various AIDC systems to improve data collection relating to such areas as monitoring patient care and billing. In many cases, several separate and distinct AIDC systems, which are used for different purposes, coexist in a single healthcare facility. Currently, bar coding is the most prominent AIDC technology and is used extensively to identify patients, drugs and consumables. Also, new healthcare regulations associated with privacy and security standards have led to the installation of new access control AIDC systems using RFID and biometrics. Further, real time location systems are being used to track patients, caregivers and equipment.

Implementation of AIDC systems, however, has not been as widespread as expected in healthcare facilities. As a result, all of the potential benefits from use of an IT system in a healthcare facility still are not being exploited. One reason for the lack of widespread implementation of AIDC systems at healthcare facilities is that the various commercially available AIDC systems usually cannot be integrated seamlessly into the IT system of a facility. Typically, the IT system infrastructure of a hospital includes several different software applications associated with different information management needs. The software applications in the healthcare environment usually include, for example, clinical information systems, administrative systems and business process modeling and analysis systems. New software applications, also serving different specialized purposes, continue to be included within an IT system of a healthcare facility.

The operation of existing and new or next generation software information applications in a healthcare facility IT system would be enhanced if real time data, such as the real time data regularly and automatically collected by the different AIDC systems also installed within a facility, were available for use by these applications. For example, existing AIDC systems record real time data about interactions between people, locations, equipment, drugs and different types of consumable supplies. This real time interaction data could serve many different purposes for the applications included within the IT system of a healthcare facility, such as, for example, automatic tracking of patient flow in an emergency department (“ED”) environment, tracking of assets and their utilization, tracking of patient and facility status in the perioperative process or automatic display of context dependent data for users of clinical information systems.

Currently, most AIDC systems installed within a facility are isolated systems and each is used, at most, by one application within the IT system. One AIDC system typically provides large amounts of data having different formatting than, and a level of detail incompatible with, that which another AIDC system provides. The lack of a common definition for data format and level of detail does not readily permit the use of the data automatically collected by several respective AIDC systems to generate useful inferences concerning interactions between and among the objects and persons in the tracking environment. As a result, information concerning these inferences is not available for use by the software applications in the IT system.

Although some techniques for using processed, automatic real time data to enhance the performance of IT applications in a healthcare environment are known, these techniques are not completely satisfactory. For example, the data collection is often limited to a single AIDC system, which severely limits the scope of the inferences that can be made about interactions and does not permit high level inferences to be made. See, for example, U.S. Published patent application No. 2002/0145534, “System and method for performing object association using a location tracking system.” In addition, other prior art products can only process data that is automatically collected using RFID technology. Further, although some prior art techniques for interfacing various data collection systems with incompatible IT data processing systems allow flexible configuration of the data event transformation rules and logical conditions associated with the events, these interfacing techniques do not provide for real time generation of interaction event information based on the collected data.

Therefore, there exists a need for system and method for establishing an interface between information processing applications of an IT system and different AIDC systems with relative ease to permit integrated processing of the real time interaction data collected by the AIDC systems for identifying interaction events occurring within a tracking environment and for providing the interaction event data to the applications in real time.

### SUMMARY OF THE INVENTION

In accordance with the present invention, a mediator system interfaces automatic data collection systems, which preferably generate real time input interaction data streams, with information management software applications, where each of the collection systems and the applications can have different and disparate data format and level of detail definitions. The mediator system formats the input interaction data from the respective collection systems to provide for integrated processing and, based on the integrated processing, generates interaction event data representative of interactions occurring within the tracking environment, such as between a location and a person or object. The mediator system, in substantially real time, formats the interaction event data according to the data format and detail definitions of the respective applications and then transmits the formatted input interaction event data to the respective applications.

In a preferred embodiment, a mediator system includes listeners, input data format converters, a data reduction filter, an input interaction builder, output data format converters and senders. The listeners receive real time input interaction data streams automatically collected by respective AIDC systems and forward the input interaction data to respective input converters. The input converters, based on data format and detail definitions concerning the respective AIDC systems and functionality criteria associated with at least one of the applications retrieved from a configuration database of the mediator system, extract the input interaction data from the respective data streams and map the extracted input interaction data into primary interaction events having a standardized format. The primary interaction events, in a preferred embodiment, concern locating, reporting and matching an activity with respect to an object or person. The primary interaction events preferably include at least two identifiers, which identify interacting entities, and a time stamp. The primary interaction event data is forwarded to a data reduction filter, which stores the forwarded primary interaction event data in an interaction event database also contained in the mediator. The reduction filter, based on filtering criteria contained in the configuration database, removes selected input interaction data, which is not useful to the applications connected to the mediator, from the received primary interaction event data stream. The reduction filter then forwards the filtered primary interaction event data to the interaction builder. The interaction builder, based on interaction building rules contained in the configuration database, generates higher level, more complex secondary interaction events based on the primary interaction event data provided by the reduction filter and, optionally, also from other interaction event data previously stored in the interaction event database. The generated secondary interaction event data is then stored in the interaction event database. The output converters receive the generated secondary interaction event data, and also associated primary interaction event data as suitable, from the builder. Based on data format and detail definitions for applications contained in the configuration database, the output converters format the interaction event data received from the builder according to the data format and detail definitions of the applications respectively associated with the output converters. The output converters then transmit the formatted interaction event data to respective senders, which constitute the interfaces with the respective applications.

In a preferred embodiment, the input converters extract from the real time input interaction data streams information associated with (i) understanding interactions between people, locations, equipment and other parts of the tracking environment; (ii) converting the input interaction data to a standardized format; (iii) generating the higher level, more complex secondary interaction events; and (iv) formatting the interaction event data for receipt by several different applications.

### BRIEF DESCRIPTION OF THE DRAWINGS

Other objects and advantages of the present invention will be apparent from the following detailed description of the presently preferred embodiments, which description should be considered in conjunction with the accompanying drawings in which:

FIG. 1 is a block diagram of a mediator system in accordance with the present invention.

FIG. 2 is a flow diagram of exemplary data processing operations performed by the mediator system of FIG. 1 in accordance with the present invention.

FIGS. 3A and 3B are representative tables of secondary interaction event data generated by an interaction builder of a mediator system in accordance with the present invention.

### DETAILED DESCRIPTION OF PREFERRED EMBODIMENTS

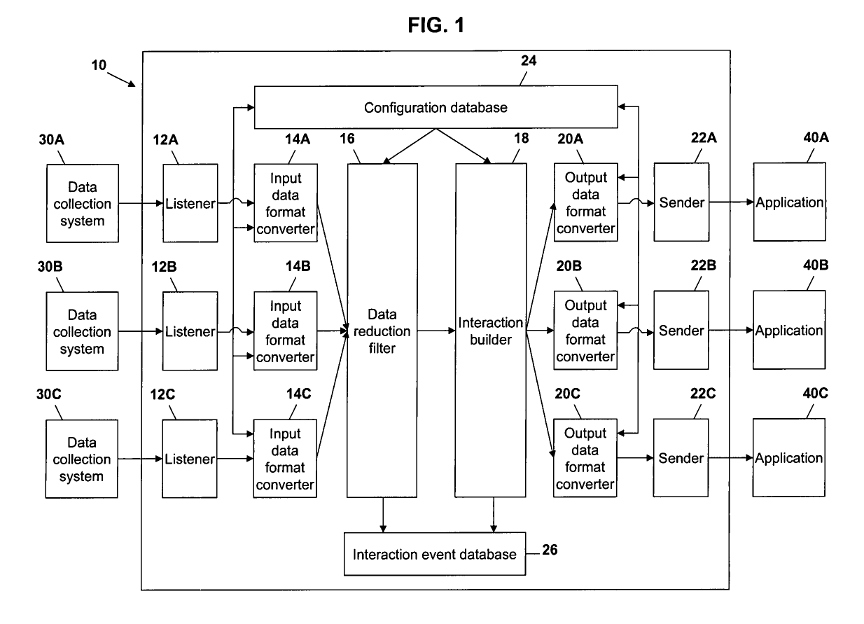

FIG. 1 shows in block diagram form a mediator system 10, in accordance with a preferred embodiment of the present invention, for receiving and formatting real time input interaction data automatically collected in a healthcare facility tracking environment by various automatic identification and data capture (“AIDC”) systems, each of which can have a different data format and level of detail definition, to permit integrated processing of the input interaction data for generating interaction event data and for providing the interaction event data in real time to software information applications, where the interaction event data is formatted based on the data format and detail definitions of the respective applications. Although the present invention is described in detail below in connection with the monitoring and processing of real time input data associated with interactions occurring within a healthcare facility, it is to be understood that the monitoring and processing of real time input interaction data streams collected by AIDC systems in other environments, such as in an industrial or military environment, can be performed in accordance with the present invention for generating interaction event data and making the interaction event data available in real time to, and in the format required by, an application.

Referring to FIG. 1, the mediator system 10 includes the functional blocks of listeners 12A-12C connected to respective input data format converters 14A-14C, a data reduction filter 16 connected to each of the input converters 14A-14C, an interaction builder 18 connected to the reduction filter 16 and output data format converters 20A-20C, and senders 22A-22C connected respectively to the output converters 20A-20C. In addition, the mediator 10 includes a configuration database 24 coupled to each of the input converters 14, the reduction filter 16, the builder 18 and each of the output converters 20. It is to be understood that each of the functional blocks of the inventive mediator, which are described below as performing data processing operations, constitutes a software module or, alternatively, a hardware module or a combined hardware/software module. In addition, each of the modules suitably contains a memory storage area, such as RAM, for storage of data and instructions for performing processing operations in accordance with the present invention. Alternatively, instructions for performing processing operations can be stored in hardware in one or more of the modules.

Referring again to FIG. 1, the listeners 12A-12C are coupled to AIDC collection systems 30A-30C and the senders 22A-22C are coupled to information management software applications 40A-40C, respectively. In addition, the mediator 10 includes an interaction event database 26 and each of the reduction filter 16 and the builder 18 is coupled to the database 26. Although the mediator 10 in FIG. 1 is illustrated with connections to only three AIDC systems 30 and three applications 40, it is to be understood that, in accordance with the present invention, the mediator 10 can be constructed to include a listener 12 and an input converter 14 for each available collection system 30, and also an output converter 20 and an associated sender 22 for each desired connection to an application 40.

The collection system 30 can be any data collection system that includes an output port which provides a real time input interaction data stream. The input interaction data represents at least two interacting identifiers and a time stamp indicating when the interaction was detected. For example, the identifiers identify an infrared-transmitting badge carried by a person and an indoor location of an infrared receiver which, for example, is included in an indoor real-time location data collection system and reads the transmitting badge. In addition, an identifier can include associated qualifier data, such as, for example, an indication that an alarm button associated with a location badge has been manually depressed. The collection system can be any AIDC data entry system, a manual data entry system or an interface with any other information collection system. The AIDC systems can include, for example, an indoor location system, a barcode system, an RFID system or a PDA data entry system as known in the art.

The listener 12 is a conventional data signal interface which provides a physical data signal interface between the mediator 10 and a collection system 30. For example, in a preferred embodiment the listener 12 is configured for connection to a TCP/IP port. The listener 12 receives the real time input interaction data stream generated at a collection system, adds a time-stamp if it is not already included in the stream, and routes the input interaction data stream to an associated input converter 14 within the mediator 10. The input interaction data stream provided by a collection system in a healthcare facility, for example, can include one or more of the following attributes concerning the tracking of an object or person being performed and the device or system being used to collect interaction data: event type being monitored, badge number, initials, primary name, last name, phone number, receiver number, receiver name, receiver phone number, collector number, sensor number, badge time in, badge time last seen, receiver type, last receiver, last receiver name, last collector, last sensor, badge type, badge type description, area ID, area description and device identification.

The configuration database 24 includes programming instructions and data for controlling data processing operations performed at the input converters 14, the reduction filter 16, the builder 18 and the output converters 20. As described below, static or non-real-time configuration data, stored in the database 24, is used to control formatting of primary interaction event data containing the real time input interaction data by the input converter 14; selectively filtering the primary interaction event data at the reduction filter 16; generating higher level, more complex secondary interaction event data at the builder 18; and formatting the interaction event data for output to an application at the output converter 20. The programming instructions stored in the database 24 are described in detail below in connection with the description of the processing operations performed by the modules of the mediator 10 coupled to the database 24.

The input data format converter 14 processes a real time input interaction data stream to extract input interaction data, formats the extracted interaction data in a standardized format as primary interaction events and then forwards the primary interaction event data to the reduction filter 16. The extraction of the input interaction data and the formatting of the primary interaction events are performed based on data format and level of detail definitions of the respective data collection systems. The data definitions for the respective collection systems and the functionality criteria for the respective applications coupled to the mediator are contained in the configuration database 24.

In an exemplary implementation of the mediator 10 in a healthcare facility environment, the input converter 12 maps the extracted interaction data into primary interaction events including an attribute event name and associated attribute values. For example, the healthcare facility related attributes can include (i) a location event having the associated attribute values of tag ID number, location ID, time stamp and data collection system; (ii) a report event, which describes reading of a report and has the associated attribute values of a report ID, RFID reader ID, read time and data collection system; and (iii) a match event, which describes reading of the tagged items to be matched with a person, such as a patient or healthcare professional, and includes the associated attributes of match ID, RFID reader ID, received time and data collection system. In still a further exemplary embodiment, the input converter 14 adds identifier type data, which indicates that a particular identifier is associated with a patient also identified in the primary interaction event data, to the primary interaction event data forwarded to the filter 16.

The data reduction filter 16 processes the primary interaction event data forwarded to it from the input converters 14 to remove input interaction data that is not meaningful for any of the applications 40 coupled to the mediator 10. The configuration database 24 includes data and software programming instructions that the filter 16 uses to identify information that needs to be removed. The filter 16 forwards the filtered primary interaction event data stream to the builder 18. The filter 16, preferably, generates filtered primary interaction event data including at least one meaningful class of interaction events. The filter 16 also stores the primary interaction event data forwarded to it from the converters 14 in the database 26.

In an exemplary embodiment, the filter 16 eliminates, from the received primary interaction event data, location event data which does not indicate a location change. This filtering operation, for example, is performed because, although a real time location system may automatically produce location event data every five seconds, an event may be meaningful to an application only if a location change is indicated. The filter 16 stores this eliminated information in the database 26 and continues to monitor the primary interaction event data received from the converters 14 until the location change criteria is satisfied. When the criteria is satisfied, the filter 16 adds primary interaction event data containing the attribute values associated with the location change event to the primary interaction event data that is forwarded to the builder 18.

The interaction builder 18 operates to combine interactions described by the primary interaction events into more complex, higher level secondary interaction events representative of interaction identities. The processing operations performed by the builder 18 are in accordance with programming instructions and programming data included in the database 24. The programming instructions performed by the builder 18 preferably include a different set of interaction building rules for each of the different applications to which the mediator 10 is connected. The builder 18 forwards, to one or more of the output converters 20, the generated secondary interaction event data, and optionally also received primary interaction event data, and also stores the generated secondary interaction event data in the database 26. The interaction event data transmitted to a particular output converter 20 depends upon the application to which the output converter is coupled.

In a preferred embodiment, the configuration database 24 includes interaction building rules corresponding to activities of a plan, schedule, workflow or process that a process flow monitoring application performs. The rules provide for the generation of secondary interaction event data that the application can use to verify whether the activities occurred. For example, the process monitoring application can include an operation schedule for a set of patients where the start of an operation for a given patient is defined as occurring when both the patient and a surgeon are simultaneously present in an operating room. The configuration database, therefore, would include an interaction building rule from which secondary interaction event data can be generated and which corresponds to the definition of the start of an operation as set forth in the monitoring application.

In a preferred embodiment, the builder 18 generates secondary interaction event data which includes primary interaction events and also is representative of a set of basic of interactions spanning a length of time.

In a further preferred embodiment, the builder 18 generates secondary interaction events including primary interactions events related to a single identifier. For example, a single identifier may be a patient and all interaction events, such as, for example, a nurse using a barcode reader to record an interaction with a patient, an indoor location system simultaneously locating the patient as being in a room and the patient being attached to a monitoring device, are related to the patient. Alternatively, the interaction events associated with the single identifier may be related to each other by a chain of interactions, such as, for example, a nurse using a barcode reader to record an interaction with a patient where the patient is attached to a telemetry monitoring device which can be located by an indoor location system.

In an exemplary embodiment, the builder 18 generates secondary interaction events from location and match event attributes included in primary interaction event data. In a further exemplary embodiment, secondary interaction events represent start and completion of an interaction. An interaction is started when all elements are located in the required location and start delay has been completed. An interaction is completed when one of the elements leaves the location or an action has been performed.

The output data format converter 20 converts the interaction event data received from the builder 18 into a data format suitable for receipt and processing by the application to which it is coupled. The data format conversion processing operations performed at the output converter 20 are controlled by programming instructions and data stored in the database 24. In a preferred embodiment, the converter 20 adds details, such as names and descriptions of the participants of an interaction to the secondary interaction events, based on programming instructions included in the database 24.

Referring to FIG. 1, in an alternative preferred embodiment, the filter 16 can be positioned in the system 10 following the builder 18 so that it removes input interaction data from at least one of the primary and secondary interaction event data before the interaction event data is supplied to the converters 20.

The sender 22 is a conventional data signal interface which provides a physical data signal interface between the mediator 12 and an application 40. For example, in a preferred embodiment the sender 12 is configured for connection to a TCP/IP port. The application 40 in a healthcare facility environment can include, for example, a scheduling system such as a process scheduling and resource management system, an order entry system, a clinical information system, a billing software system, an equipment maintenance system, a medication distribution tracking system, a process monitoring/variance detection system and a laboratory/radiology system. The application 40 can be located on a mobile terminal, laptop, PDA, desktop computer or like data processing and display device.

In an exemplary embodiment, the mediator 10 includes a predetermined configuration data listener interface, operating similarly as a listener 12, which receives configuration data from a separate configuration application or an external IT application and furthermore stores the configuration data in the database 24.

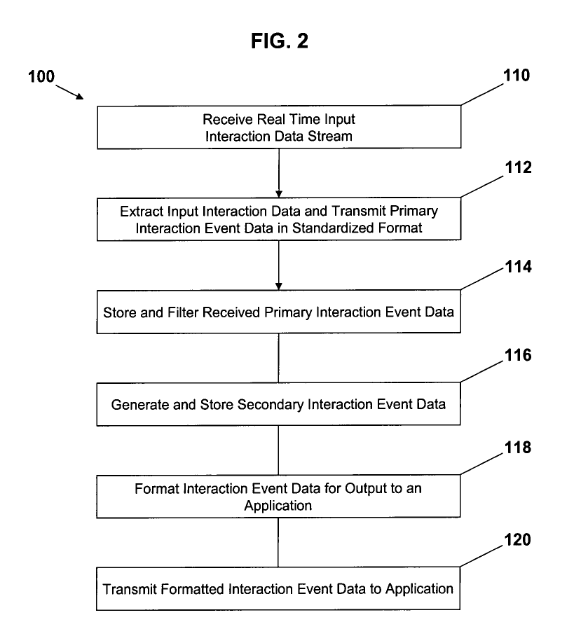

FIG. 2 illustrates data processing operations performed at the mediator 10 according to a preferred flow process 100, which provides for generation of secondary interaction event data based on real time input interaction data for receipt, in real time or substantially real time, at applications connected to the mediator 10 in accordance with the present invention. Referring to FIGS. 1 and 2, in step 110 the listeners 12 receive real time input interaction data streams provided by the respective collection systems 30. The listeners 12 route the input interaction data streams to the respective input converters 14.

In step 112, the input converters 12, which have retrieved from the database 24 data processing instructions associated with the data definitions of the respective collection systems, extract the input interaction data from the streams and generate, based on the extracted input interaction data, primary interaction event data having a standardized format. The availability of the primary interaction event data in a standardized format advantageously provides for integrated processing of input interaction data at the builder 18. The converters 12 transmit the primary interaction event data to the reduction filter 16.

In step 114, the filter 16, which has retrieved its data processing instructions from the database 24, stores in the database 26 the primary interaction event data received from the respective input converters 14. In addition, the filter 16 processes the received primary interaction event data to retain only meaningful interaction events. The elimination of input interaction data is performed in relation to the applications 40 connected to the mediator 10. The filter 16 forwards the filtered primary interaction event data to the builder 18.

In step 116, the builder 18, which has retrieved processing instructions relating to the functionality of the applications 40 from the database 24, processes the primary interaction event data received from the filter 16 to generate secondary interaction event data representative of higher level, more complex interactions than those represented in the primary interaction events. The generation of the secondary interaction event data optionally includes retrieving and processing suitable primary and secondary interaction event data stored in the database 26. The builder 18 stores the currently generated secondary interaction event data in the database 26 for subsequent use in identifying still more interaction identities, which thereby results in the generation of additional secondary interaction events. In addition, the builder 18 transmits to the output converters 20 the currently generated secondary interaction event data, and optionally selected primary interaction event data forwarded by the filter 16 and, also optionally, selected primary and secondary interaction event data retrieved from the database 26. The specific interaction event data transmitted to a particular output converter 20 depends on the operating requirements of the applications 40 connected to the mediator 12. The builder 18 generates a plurality of data streams of interaction events corresponding to the applications 40 for receipt at the respective output converters 20.

In step 118, the output converters 20 format the received secondary, and optionally primary, interaction event data according to the data format and detail definitions of the respective applications 40 to which the senders 22 coupled to the converters 20 are also coupled.

In step 120, the senders 22 forward the formatted interaction event data to the respective applications 40.

Thus, the mediator 10 is a dynamic gateway between automatic data collection systems and data analysis software. When applied in a healthcare facility environment, the mediator provides that input interaction data collected in real time can be used to support and improve patient flow and resource management in and between various hospital departments. The generation of complex (secondary) interaction event data in real time, based on input interaction data collected in real time by an existing data collection system or a data collection system added in the future, permits various departments in a healthcare facility to coordinate in real time and have information available in real time. The availability of real time information permits improved planning capability.

In an exemplary implementation of the mediator 10 of the present invention, the mediator 10 connects several automatic real time data collection systems in a healthcare facility environment to a healthcare facility patient tracking and monitoring application. The environment, for example, is an ED environment including an infrared-based location activity data collection system which uses low-cost tracking badges for patient tracking. In an alternative preferred embodiment, a wireless local area network-based location system tracks the location of wirelessly connected PDAs carried by healthcare professionals to locate the nurses and physicians when needed, such that the data collection system does not continuously track nurses and physicians. In addition, a bar coding based data collection system is used to prevent medication error. Further, a radio frequency identification (“RFID”) system tracks patient records, for example, X-ray images. The above-identified data collection systems are connected to respective listeners of the mediator 10. The mediator 10 performs integrated processing on the input interaction data provided by the collection systems and generates secondary interaction event data and transmits such event data, properly formatted, to a process modeling and monitoring application 40 connected to a sender. For example, the builder 18 processes primary interaction event data obtained from the real time input interaction data streams, retrieving primary interaction event data and secondary interaction event data stored in the database 26 as suitable, to identify events involving a physician staying in a patient's room for a given time while the patient is also present. The builder 18 combines the primary interaction events, such as a physician being in a given room, which is indicated by the input interaction data provided by a PDA tracking system, and a patient also being in the same room, which is indicated by the input interaction data provided by the patient tracking system, into a secondary input interaction event that is transmitted to the process monitoring application. The application then automatically, or after a confirmation from the physician, generates and stores in its memory a data record indicating that the physician has seen the patient and updates the patient's status in the care process accordingly. Similarly, at a subsequent time during the patient's stay at the ED, the builder 18 generates a secondary interaction event indicating that a nurse has read the ID of a medication dosage while co-located with the patient in the patient's room. The process monitoring application, after receipt of such interaction event data in real time, again, automatically or semi-automatically, stores a data record in its memory concerning the reception of the medication by the patient and updates the patient status in the care process. Further, at still a later time, the builder 18 generates an secondary interaction event representative of the availability of the patient's X-ray images based on primary interaction event data associated with detection of an interaction by a tabletop RFID reader, which is positioned in the nursing station, indicating that the image file is on the table.

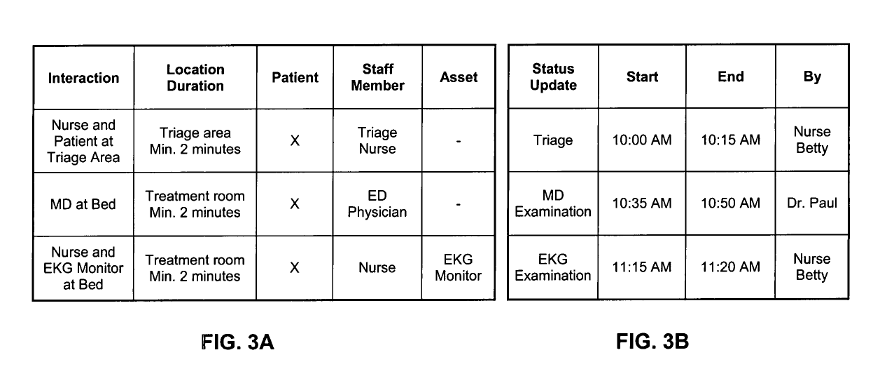

FIGS. 3A and 3B are tables illustrating exemplary secondary interaction event data including primary interaction events in a healthcare facility associated with a single identifier, i.e., a patient. It is noted that the attributes associated with a single identifier can include, for example, type of interaction, data collector, description of interaction for user interface, interaction type identification, interaction identification created by builder, location of interaction, location of description, interaction start and complete times, patient tag ID, patient tag bearer ID, staff tag ID, staff tag bearer ID, asset tag ID and asset tag bearer ID.

The secondary interaction event data illustrated in FIG. 3A can be generated, for example, based on input interaction data provided from (i) an infrared data collection system and including the attributes of identity of an infrared badge associated with a specific EKG monitor, the number of the hospital room in which an infrared sensor detecting the infrared badge is located and the times of day that the infrared sensor detected the infrared badge; (ii) an RFID data collection system and including the attributes of identities of first and second RF badges respectively associated with an EKG report and a patient, the number of the hospital room in which an RF sensor detecting the first and second RF badges is located and the times of day that the RF sensor detected the first and second RF badges; and (iii) a smart card data collection system and including the attributes of the identification numbers of respective smart cards used by a specific nurse and a specific physician to enter and exit a hospital room, the number of the hospital room associated with the smart card reader that read the smart cards used by the nurse and physician to enter and exit the hospital room and the times of day that the smart card reader in the hospital room read the smart cards of the nurse and physician. The input converters of the mediator generate primary interaction event data in a standardized format from the respective input interaction data streams (i), (ii) and (iii). For example, the primary interaction event data generated from the input interaction data stream supplied by the smart card collection system indicates co-location of the nurse and physician in a specific hospital room for a predetermined time period. In addition, the primary interaction event data generated from the input interaction data stream supplied by the RFID collection system indicates co-location of the patient and the EKG report in the same hospital room for the same predetermined time period that the physician and nurse were in the hospital room as indicated in the primary interaction event data associated with the smart card collection system. Further, the primary interaction event data generated from the input interaction data stream supplied by the infrared collection system indicates the presence of the EKG monitor in the same hospital room at the same predetermined times that (i) the physician and nurse were detected as entering and exiting the hospital room by the smart card collection system and (ii) the patient and the EKG report were detected as being in the room based on the primary interaction event data associated with the RFID collection system. Based on this primary interaction event data, which indicates co-location of a patient, an EKG monitor, an EKG report, a physician and a nurse in the same hospital room for a predetermined time period, the builder generates secondary interaction event data which is formatted for receipt and processing at a billing application and a clinical information application coupled to respective output converters and senders. For example, the mediator generates and transmits to the billing application secondary interaction event data identifying that an EKG was used on a patient on a certain date by a certain nurse and physician, which permits the billing application to generate a billing entry associated with the physician and nurse providing EKG services to the patient. In addition, the mediator generates and transmits to the clinical application secondary interaction event data including the same information, namely, that an EKG was used on the patient on a certain date by a certain nurse and doctor. Based on this information, the clinical application updates the patient's electronic clinical chart to indicate that a certain required EKG procedure was performed by the identified nurse and physician.

In a further preferred embodiment, the builder 18 processes primary interaction event data associated with a physician and the patient being in the same physical location, and generates corresponding secondary interaction events. The mediator 10 then suitably forwards data representative of these complex secondary interaction events, through the sender, to the administrative IT system of the hospital and the interaction events are used as a basis for billing.

In a further preferred embodiment, the mediator 10 couples a clinical data collection system, such as a patient monitoring system, to suitable applications. The mediator 10, based on the configuration data for the suitable applications, extracts interaction events from the monitoring system data stream. For example, a location data collection system separately tracks equipment, to permit the mediator to extract this tracking information to generate primary and secondary interaction event data. The mediator 10 transmits the primary and secondary interaction event data, which includes the location tracking information, to an asset management application. In addition, the mediator 10 combines the location information with primary interaction events indicating the assignment of a patient to a particular monitor to generate secondary interaction event data, thereby permitting the location of a patient to be determined even if a patient tracking system is not in use.

Although preferred embodiments of the present invention have been described and illustrated, it will be apparent to those skilled in the art that various modifications may be made without departing from the principles of the invention.

What is claimed is:

1. A method for generating interaction events associated with a tracking environment in substantially real time using substantially real time input interaction data collected by a plurality of automatic data collection systems comprising:
receiving a plurality of substantially real time input interaction data streams generated at a plurality of respective automatic data collection systems;
extracting the input interaction data from the data streams according to data format and detail definitions of the respective collection systems generating the interaction data streams;
generating primary interaction events based on the extracted interaction data, wherein the primary interaction events have a standardized processing format;
generating secondary interaction events based on the primary interaction events; and
formatting the secondary interaction events for reception by at least one software application based on configuration requirements of the at least one software application.

2. The method of claim 1 further comprising:
transmitting the formatted secondary interaction events in substantially real time to the at least one software application.

3. The method of claim 1 further comprising:
filtering at least one of the primary and secondary interaction events to remove input interaction data according to predetermined criteria.

4. The method of claim 2 further comprising:
formatting at least one of the primary interaction events for output in accordance with the configuration requirements of the at least one application and transmitting the primary interaction events formatted for output in substantially real time to the at least one application.

5. The method of claim 1, wherein at least one of the primary interaction events includes at least a location attribute, an object/person attribute and a time attribute.

6. The method of claim 1 further comprising:
storing the primary interaction events and the secondary interaction events in a memory; and
following the storing and based on the configuration requirements for the at least one application, retrieving from the memory at least one of (i) the stored primary interaction events and (ii) the secondary interaction events, and using the retrieved interaction events for generating additional secondary interaction events.

7. The method of claim 1, wherein at least one of the secondary interaction events indicates co-location of at least two persons.

8. The method of claim 1, wherein at least one of the secondary interaction events indicates co-location of at least one person with at least one object.

9. The method of claim 1, wherein at least one of the secondary interaction events indicates co-location, for a predetermined time interval, of (i) at least two persons or (ii) at least one person with at least one object.

10. The method of claim 1, wherein the generating of the secondary interaction events is based on an interaction building rule corresponding to an activity of a process step performed by the at least one application.

11. The method of claim 1, wherein the secondary interaction events are formatted for transmission to at least one of a billing software application, a clinical information application, a medication distribution tracking application and a process monitoring/variance detection application and a process scheduling and resource management application.

12. The method of claim 1 further comprising:
filtering the primary interaction events to remove input interaction data according to predetermined criteria, and wherein the generating secondary interaction events uses the filtered primary interaction events.

13. A system for generating interaction events associated with a tracking environment in substantially real time using substantially real time input interaction data collected by a plurality of automatic data collection systems comprising:
a plurality of listeners for interfacing with a plurality of respective automatic data collection systems, wherein the listeners in substantially real time forward substantially real time input interaction data streams provided by the respective collection systems;
a plurality of input data format converters respectively coupled to the plurality of listeners and for receiving the interaction data streams forwarded by the respective listeners;
an interaction builder coupled to the input converters and to a plurality of output data format converters;
a plurality of senders respectively coupled to the plurality output converters and for interfacing with a respective plurality of applications;
a configuration data database coupled to the input and output converters and the builder;
an interaction event data database coupled to the builder;
wherein each of the input converters generates primary interaction event data based on the input interaction data stream received from the associated listener and data format and detail definitions of the collection system generating the input interaction data stream, wherein the primary interaction event data has a standardized processing format, wherein the configuration database contains the configuration requirements and the data definitions;
wherein the builder generates secondary interaction events based on the primary interaction events; and
wherein the output converters format the secondary interaction events for reception by at least one of the software applications.

14. The system of claim 13, wherein the senders transmit to the respective software applications in substantially real time the formatted secondary interaction events received from the respective output converters.

15. The system of claim 13 further comprising:
a data reduction filter coupled to the builder, the configuration database and each of the input converters, wherein the reduction filter filters at least one of the primary and secondary interaction events to remove interaction data according to predetermined criteria.

16. The system of claim 14, wherein the builder transmits at least one of the primary interaction events received from the input converters to at least one of the output converters and wherein the output converter formats at least one of the primary interaction events for output to the application coupled to the sender associated with the output converter.

17. The system of claim 13, wherein at least one of the primary interaction events includes at least a location attribute, an object/person attribute and a time attribute.

18. The system of claim 13 further comprising an interaction event memory, wherein the builder stores the primary interaction events and the secondary interaction events in the interaction event memory, and wherein the builder, based on the configuration requirements for the at least one application, retrieves from the memory at least one of (i) the stored primary interaction events and (i) the secondary interaction events and uses the retrieved interaction events to generate additional secondary interaction events.

19. The system of claim 13, wherein at least one of the secondary interaction events indicates co-location of at least two persons.

20. The system of claim 13, wherein at least one of the secondary interaction events indicates co-location at least one person with at least one object.

21. The system of claim 13, wherein at least one of the secondary interaction events indicates co-location, for a predetermined interval, of (i) at least two persons or (ii) at least one person with at least one object.

22. The system of claim 13, wherein the secondary interaction events are generated based on an interaction building rule corresponding to an activity associated with a process step performed by the at least one application.

23. The system of claim 13, wherein the secondary interaction events are formatted for transmission to at least one of a billing software application, a clinical information application, medication distribution tracking application, a process monitoring/variance detection application and a process scheduling and resource management application.

24. The system of claim 13, wherein the data collection systems includes at least one of an radio frequency identification system, a smart card reader system, an indoor location system, a voice recognition system, a bar coding system, a biometric recognition system and a machine vision system.

25. The system of claim 13 further comprising:
a data reduction filter coupled to the builder, the configuration database and each of the input converters, wherein the reduction filter filters the primary interaction events to remove interaction data according to predetermined criteria, and wherein the builder generates secondary interaction events based on the filtered primary interaction events.
